(19) United States
(12) Patent Application Publication
(10) Pub. No.: US 2019/0142669 A1
(43) Pub. Date: May 16, 2019

(54) Transfer Board Having a Hydrophilic Multilayer Sliding Surface Member

(71) Applicant: Stephan Tobias, St. Augustine, FL (US)

(72) Inventor: Stephan Tobias, St. Augustine, FL (US)

(21) Appl. No.: 15/810,266

(22) Filed: Nov. 13, 2017

(51) Int. Cl. A61G 7/10; B32B 7/06; B32B 7/12; B32B 27/08

(52) U.S. Cl. CPC A61G 7/103; B32B 7/06; B32B 7/12; B32B 27/08; B32B 2535/00; B32B 2255/10; B32B 2307/728; B32B 2255/26; B32B 2307/7265

(57) ABSTRACT

An improved transfer board adapted to facilitate the transfer of a person between a wheelchair and another surface, the transfer board having a rigid body member and a multilayer sliding surface member adhered to the upper surface of the body member, the multilayer sliding surface member having a hydrophilic upper contact layer, most preferably with a wetting contact angle of less than approximately 20 degrees.

### BACKGROUND OF THE INVENTION

This application relates generally to the field of devices facilitating the transfer of a person between a wheelchair and another surface, such as a bed, a car seat, a bench, etc., such devices being commonly referred to as transfer or slide boards. More particularly, the invention relates to such boards having an improved low-friction upper surface for use in situations where the transfer board contacts bare skin, and particularly damp or wet skin.

Transfer or slide boards, (to be referred to collectively herein as transfer boards) are well known as they provide a safe and convenient method for independent and assisted transfers of persons who have limited or no use of their legs. The transfer board is positioned so as to bridge the gap between two surfaces, such as a wheelchair and a bed. The user then lifts her/himself or is lifted off the first surface, slides or is slid by aides across the transfer board and onto the second surface. Transfer boards are generally thin rectangular members with sufficient rigidity and strength to support the weight of the person. The transfer boards are typically made of wood or a rigid plastic, with the wooden transfer boards being provided with a coating of lacquer, polyurethane or the like to waterproof the wood. Hand slots are often provided, and the upper surface may be sloped or slanted, particularly at each end.

A significant problem with known transfer boards is that the upper surface, while suitable for clothed persons, does not present an optimum low-friction surface for contact with naked skin, which tends to stick to the surfaces of known transfer boards, especially when the skin is damp or wet, such as after a bath or shower. This results in discomfort or in extreme cases actual tearing or shearing of the skin, which can result in a long and expensive healing process. Additionally, the friction between the transfer board and wet or damp skin may occur to such a degree that independent transfer is not possible.

It is an object of this invention to provide an improved transfer board, one having an upper surface that addresses the problems set forth above arising from bare skin contact, particularly with damp or wet skin. It is an object to provide such a transfer board wherein a multilayer sliding surface member is adhered to the upper surface of the transfer board, the multilayer sliding surface member having a waterproof substrate layer, a hydrophilic upper surface and an adhesive lower surface. It is a further object to provide such a transfer board wherein the multilayer sliding surface member is readily removable by peeling to allow for replacement when the beneficial properties of the member have significantly diminished.

### SUMMARY OF THE INVENTION

The invention is an improved transfer board adapted to facilitate the transfer of a person between a wheelchair and another surface, the transfer board comprising a rigid body member and a multilayer sliding surface member adhered to the upper surface of the body member, the multilayer sliding surface member comprising a hydrophilic upper contact layer, most preferably with a wetting contact angle of less than approximately 20 degrees. The transfer board body member may be composed of wood, plastic or any other material possessing sufficient strength and rigidity to readily support the body weight of a person.

The multilayer sliding surface member adhered to the body member comprises a waterproof substrate layer, composed for example of a polymer film material, having a suitable adhesive present on its lower surface for adhesion onto the upper surface of the body member. The layer forming the hydrophilic upper contact layer of the multilayer sliding surface member may be permanently applied to the waterproof substrate layer by various methods, including dipping, spraying or rolling. Preferably, the adhesive is chosen such that the bond between the substrate layer and the body member is not permanent, allowing the multilayer sliding surface member to be removed from the transfer board body member by peeling, the exposed surface of the transfer board being undamaged by removal of the multilayer sliding member, and replaced with a new multilayer sliding surface member as needed.

In alternative language, the invention is a transfer board comprising a body member having an upper surface; and a multilayer sliding surface member adhered to the upper surface of the body member; wherein the multilayer sliding surface member comprises a waterproof substrate layer having a lower surface and an upper surface, an adhesive layer joined to the lower surface of the waterproof substrate layer, and a hydrophilic contact layer joined to the upper surface of the waterproof substrate layer, and further wherein the multilayer sliding surface is at least substantially coextensive with the upper surface of the body member. Furthermore, such a transfer board wherein the hydrophilic contact layer has a wetting contact angle of less than approximately 20 degrees; wherein the adhesive layer is composed of an adhesive such that the multilayer sliding surface member is removable from the upper surface of the body member by peeling; wherein the waterproof substrate is composed of a polymer film; and/or wherein the hydrophilic contact layer is a coating chosen from the group of hydrophilic coatings including hydrophilic acrylics, polyvinylpyrrolidone, hyaluronic acid, acrylamide, maleic anhydride, hydrophilic polyurethanes and urethanes.

Alternatively, a transfer board adapted for supporting and transferring a person from one surface to another surface, the transfer board comprising a rigid body member having an upper surface; and a multilayer sliding surface member adhered to the upper surface of the body member; wherein the multilayer sliding surface member comprises a waterproof substrate layer composed of a polymer film and having a lower surface and an upper surface, an adhesive layer joined to the lower surface of the waterproof substrate layer, and a hydrophilic contact layer having a wetting contact angle of less than approximately 20 degrees joined to the upper surface of the waterproof substrate layer, and further wherein the multilayer sliding surface is at least substantially coextensive with the upper surface of the body member. Furthermore, such a transfer board wherein the adhesive layer is composed of an adhesive such that the multilayer sliding surface member is removable from the upper surface of the body member by peeling; and/or wherein the hydrophilic contact layer is a coating chosen from the group of hydrophilic coatings including hydrophilic acrylics, polyvinylpyrrolidone, hyaluronic acid, acrylamide, maleic anhydride, hydrophilic polyurethanes and urethanes.

### BRIEF DESCRIPTION OF THE DRAWINGS

FIG. 1 is top view of a representative embodiment of an improved transfer board having a multilayer sliding surface member adhered to the upper surface of the body member.

FIG. 2 is a partial cross-sectional of the transfer board of FIG. 1, showing a representative embodiment of the multilayer sliding surface member adhered onto the body member.

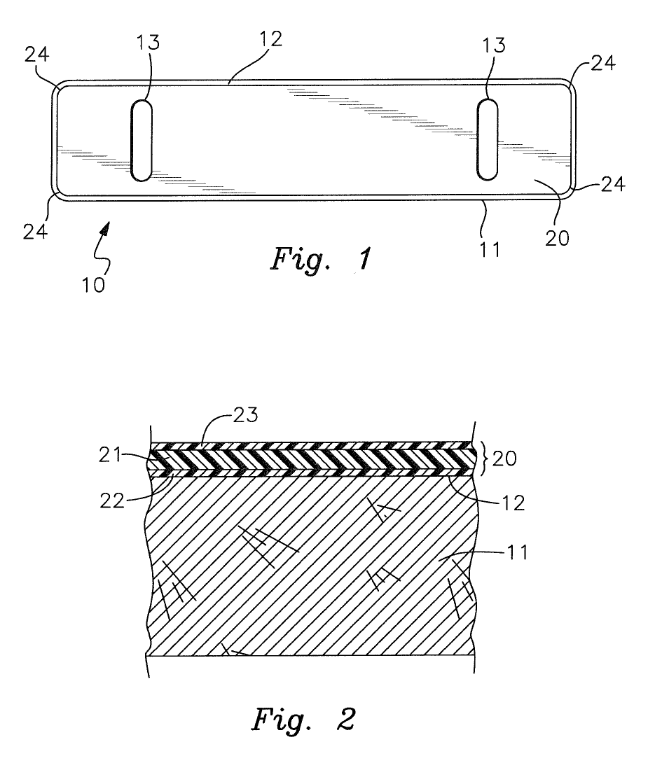

### DETAILED DESCRIPTION OF THE INVENTION

With reference to the drawings, the invention will now be described in detail. It is to be understood that the drawings are not meant to be restrictive as to the scope of the invention, are not to scale, and are provided for descriptive and illustrative purposes.

In general, the invention is an improved transfer board 10 adapted to facilitate the transfer of a person between a wheelchair and another surface, the transfer board 10 comprising in combination a rigid body member 11 and a multilayer sliding surface member 20 adhered to the upper surface 12 of the body member 11. The body member 11 is a relatively thin member, generally rectangular in configuration, of sufficient rigidity and strength to support the weight of a person being transferred between two surfaces, such as between a wheelchair and a bed, car seat, bench, etc. The body member 11 may be composed of any material possessing the requisite structural properties, such as wood, plastic, metal or the like. Most preferably the body member 11 is formed of a waterproof material, or alternatively the body member 11 may be coated with a lacquer, polyurethane or similar coating to make the body member 11 waterproof. The body member 11 may be provided with notches, cut-outs or hand slots 13 to better facilitate transfer.

The multilayer sliding surface member 20 is a thin, sheet-like member sized to be fully or at least substantially coextensive with the upper surface 12 of the body member 11, such that all or the majority of the upper surface 12 is covered by the multilayer sliding surface member 20 and such that corners 24 are defined on the multilayer sliding surface member 20. The multilayer sliding surface member 20 comprises a waterproof substrate layer 21, composed for example of a relatively thin polymer film material. An adhesive layer 22 formed of an adhesive suitable for adhering the substrate layer 21 to the upper surface 12 of the body member 11 is provided on the lower surface of the substrate layer 21.

The multilayer sliding surface member 20 further comprises a hydrophilic contact layer 23 at least substantially coextensively joined to the upper surface of the substrate layer 21, the material of composition of the hydrophilic contact layer 23 being chosen such that the surface most preferably possesses a wetting contact angle of less than approximately 20 degrees. The hydrophilic property of the contact layer 23 provides an upper exterior surface for the transfer board 10 with friction-reducing properties that are not lessened in wet conditions, producing an optimal low-friction surface when contacting wet or damp bare skin.

The hydrophilic contact layer 23 of the multilayer cover member 20 may be applied to the waterproof substrate layer 21 by various methods. The contact layer 23 may be composed of various types of medical hydrophilic coatings, such as the type used for catheters and guidewires inserted into the body, that are intended to reduce friction when wetted with water. The chemistries of these hydrophilic coatings can be either thermal or UV cured, or chemically grafted and assembled coatings. The coatings may be made with hydrophilic acrylics, PVP (polyvinylpyrrolidone), hyaluronic acid, acrylamide, maleic anhydride, hydrophilic polyurethanes and urethanes, to name a few. The preferred embodiment is a bilaminar thermal cured coating of an acrylic basecoat and a polyacrylic topcoat with a wetted contact angle below 20°.

The hydrophilic upper contact layer 23 may be applied in different ways depending on the particular hydrophilic polymer chosen. Spray, dip, and rolling methods will work for the liquid applied for pre-formulated coating materials. Chemically assembled and grafted coatings are applied in reaction vessels. Some thermoplastic hydrophilic polymers may be extruded directly into thin film sheets. In a preferred embodiment, a basecoat layer with formulated chemical crosslinkers is rolled onto the adhesive backed film substrate layer 21 and cured. A hydrophilic topcoat layer is then rolled onto to the basecoat and cured to covalently bond the hydrophilic topcoat layer to the basecoat to form the contact layer 23.

Most preferably, the adhesive is chosen such that the multilayer sliding surface member 20 is sufficiently adhered to the body member 11 but remains easily removable from the body member 11 after a period of time by peeling, as this allows the multilayer sliding surface member 20 to be peeled from the body member 11 and replaced with a new multilayer sliding surface member 20 should the lubricious properties of the contact layer 23 be significantly reduced or compromised due to wear, physical damage such as scratches, contact with degradative chemicals or materials, contamination, etc. By providing a replaceable, peelable, multilayer sliding surface member 20, the body member 11 can be re-used such that it is not necessary to purchase a replacement transfer board 10. The terms “peeling” and “peelable” and the phrase “removable by peeling” or the like shall be defined herein as an operation whereupon removal of the multilayer sliding surface member 20 does not damage the surface of the transfer board 10 exposed after the multilayer sliding surface member 20 is removed and as an operation which can be easily accomplished without requiring special tools or destruction of the multilayer sliding surface member 20, for example, by tearing, shredding or scraping, and is accomplished by beginning to peel on a corner of the multilayer sliding surface member 20 with the multilayer sliding surface member 20 removed in one piece.

A transfer board 10 as described addresses the significant problem with known transfer boards in that the upper surface, while suitable for clothed persons, does not present an optimum low-friction surface for contact with naked skin, which tends to stick to the surfaces of known transfer boards, especially when the skin is damp or wet, such as after a bath or shower. This results in discomfort or in extreme cases actual tearing or shearing of the skin, which can result in a long and expensive healing process. Additionally, the friction between the transfer board and wet or damp skin may occur to such a degree that independent transfer is not possible. By combining the multilayer sliding surface member 20 with the body member 11, the resulting transfer board 10 minimizes or eliminates the known problems.

It is understood that equivalents and substitutions for certain elements described above may be obvious to those of ordinary skill in the art, and therefore the true scope and definition of the invention is to be as set forth in the following claims.

I claim:

1. A transfer board comprising:
a body member having an upper surface; and
a multilayer sliding surface member adhered to the upper surface of the body member;
wherein the multilayer sliding surface member comprises a waterproof substrate layer having a lower surface and an upper surface, an adhesive layer joined to the lower surface of the waterproof substrate layer, and a hydrophilic contact layer joined to the upper surface of the waterproof substrate layer, and further wherein the multilayer sliding surface is at least substantially coextensive with the upper surface of the body member.

2. The transfer board of claim 1, wherein the hydrophilic contact layer has a wetting contact angle of less than approximately 20 degrees.

3. The transfer board of claim 1, wherein the adhesive layer is composed of an adhesive such that the multilayer sliding surface member is removable from the upper surface of the body member by peeling.

4. The transfer board of claim 2, wherein the adhesive layer is composed of an adhesive such that the multilayer sliding surface member is removable from the upper surface of the body member by peeling.

5. The transfer board of claim 1, wherein the waterproof substrate is composed of a polymer film.

6. The transfer board of claim 2, wherein the waterproof substrate is composed of a polymer film.

7. The transfer board of claim 3, wherein the waterproof substrate is composed of a polymer film.

8. The transfer board of claim 4, wherein the waterproof substrate is composed of a polymer film.

9. The transfer board of claim 1, wherein the hydrophilic contact layer is a coating chosen from the group of hydrophilic coatings including hydrophilic acrylics, polyvinylpyrrolidone, hyaluronic acid, acrylamide, maleic anhydride, hydrophilic polyurethanes and urethanes.

10. The transfer board of claim 4, wherein said multilayer sliding surface member has corners and is removable in one piece without tearing, scraping or shredding by peeling by beginning to peel a corner of the multilayer sliding surface member.

11. A transfer board adapted for supporting and transferring a person from one surface to another surface, the transfer board comprising:
a rigid body member having an upper surface; and
a multilayer sliding surface member adhered to the upper surface of the body member;
wherein the multilayer sliding surface member comprises a waterproof substrate layer composed of a polymer film and having a lower surface and an upper surface, an adhesive layer joined to the lower surface of the waterproof substrate layer, and a hydrophilic contact layer having a wetting contact angle of less than approximately 20 degrees joined to the upper surface of the waterproof substrate layer, and further wherein the multilayer sliding surface is at least substantially coextensive with the upper surface of the body member.

12. The transfer board of claim 11, wherein the adhesive layer is composed of an adhesive such that the multilayer sliding surface member is removable from the upper surface of the body member by peeling.

13. The transfer board of claim 12, wherein said multilayer sliding surface member has corners and is removable in one piece without tearing, scraping or shredding by peeling by beginning to peel a corner of the multilayer sliding surface member.

14. The transfer board of claim 11, wherein the hydrophilic contact layer is a coating chosen from the group of hydrophilic coatings including hydrophilic acrylics, polyvinylpyrrolidone, hyaluronic acid, acrylamide, maleic anhydride, hydrophilic polyurethanes and urethanes.

15. A transfer board adapted for supporting and transferring a person from one surface to another surface, the transfer board comprising:
a rigid body member having an upper surface; and
a multilayer sliding surface member adhered to the upper surface of the body member;
wherein the multilayer sliding surface member comprises a waterproof substrate layer composed of a polymer film and having a lower surface and an upper surface, an adhesive layer joined to the lower surface of the waterproof substrate layer, wherein the adhesive layer is composed of an adhesive such that the multilayer sliding surface member is removable from the upper surface of the body member by peeling, and a hydrophilic contact layer having a wetting contact angle of less than approximately 20 degrees joined to the upper surface of the waterproof substrate layer, and further wherein the multilayer sliding surface is at least substantially coextensive with the upper surface of the body member;
wherein said multilayer sliding surface member has corners and is removable in one piece without tearing, scraping or shredding by peeling by beginning to peel a corner of the multilayer sliding surface member.

16. The transfer board of claim 15, wherein the hydrophilic contact layer is a coating chosen from the group of hydrophilic coatings including hydrophilic acrylics, polyvinylpyrrolidone, hyaluronic acid, acrylamide, maleic anhydride, hydrophilic polyurethanes and urethanes.
